(19) United States
(12) Patent Application Publication
(10) Pub. No.: US 2022/0138303 A1
(43) Pub. Date: May 5, 2022

(54) Certificate Management in a Technical Installation

(71) Applicant: Siemens Aktiengesellschaft, Muenchen (DE)

(72) Inventors: Benjamin LUTZ, Pfinztal, (DE); Anna PALMIN, Karlsruhe (DE)

(21) Appl. No.: 17/512,755

(22) Filed: Oct. 28, 2021

(30) Foreign Application Priority Data
Oct. 29, 2020 (EP) 20204745

(51) Int. Cl. G06F 21/33; G06F 21/73; G06F 21/64

(52) U.S. Cl. CPC G06F 21/33; G06F 21/64; G06F 21/73

(57) ABSTRACT

A control system for a technical installation includes a certification body, first and second installation components, wherein the certification body issues/revokes certificates for the first and second installation components, where a certificate revocation list service receives from the certification body a certificate revocation list having certificates already revoked by the certification body and provides the certificate revocation list to the components, a certificate revocation list distribution service implemented on the first and second installation components receives the certificate revocation list from the certificate revocation list service and stores the certificate revocation list in a storage device of the respective installation component, and where the certificate revocation list distribution service of an installation component additionally in each case connects to the certificate revocation list distribution service on another installation component and receives the certificate revocation list from this certificate revocation list distribution service on the other component.

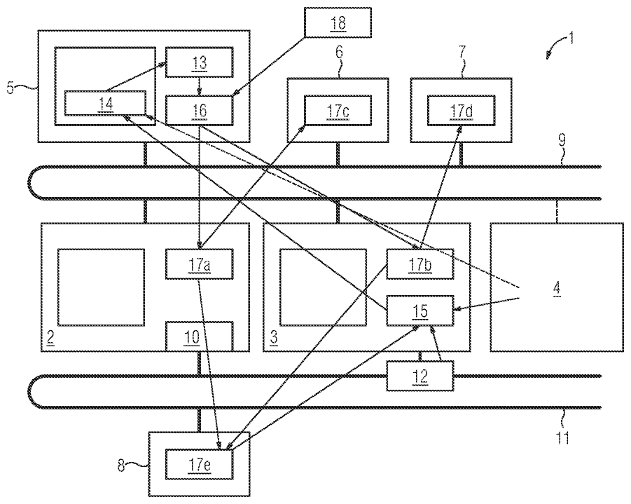

### BACKGROUND OF THE INVENTION

### 1. Field of the Invention

The invention relates to a control system of a technical installation, in particular a production installation or process installation, an installation component system and to the use of the control system.

### 2. Description of the Related Art

In modern process control technical installations, protocols are increasingly being used for secure communication (for example, via OPC Unified Architecture (OPC UA) or Transport Layer Security (TLS)). This makes the use of “digital certificates” necessary. In some installations, for this purpose a public key infrastructure (PKI) is configured and the public key infrastructure particularly includes a trustworthy “issuing” certification authority (issuing CA) as a central component and the certification authority can issue and sign certificates for installation components. As a consequence, the certification authority can certify or confirm the trustworthiness of installation components.

The trustworthiness of the issuing CA itself can be ensured by virtue of the fact that its own certificate is signed by a trustworthy intermediate CA and the certificate of the intermediate CA is, in turn, signed by a further intermediate CA. IN general, the entire chain leads to a root certification authority (root CA) that is self-signed (i.e., has signed its own certificate itself). The root certification authority is verifiably secure in accordance with the certificate policies that are stated in the RFC 3647. The root CA can also be referred to as a trust anchor.

A registration authority (RA) as a further central component of a public key infrastructure of an automation installation has the particular task of receiving the certificate requests (certificate signing requests (CSR)) from diverse installation components. In consultation with an RA inventory, which is also referred to as a device inventory, and the contents of the RA inventory that can originate, for example, from a configuration description of a technical installation, it is possible for the registration authority to validate the certificate requests. Such a registration authority is disclosed, for example, in the publication EP 3 402 152 A1.

With reference to the identification, which is contained in the certificate request, of the respective device or the installation component from which the certificate request originates, the registration authority checks during the validation whether the device is stored in the RA inventory (and consequently in the installation context is fundamentally authorized to apply for and to receive certificates). The registration authority subsequently checks the certificate request including its signature.

If a standard protocol is used for the certificate management (for example, CMP according to RFC 4210), the certificate requests can be requests for the purpose of the initial application (bootstrapping) or renewal (update) of certificates. In the case of bootstrapping, the certificate request is generally signed using the device certificate (manufacturer device certificate (MDC)), while in the case of the update the operative certificate (OC) that is finally issued is used for the signing. Alternatively or in addition to the device certificate (that is issued during the production of a manufacturer CA), it is also possible to use the customer certificate (customer device certificate (CDC)) that the device has received after a corresponding check in the customer installation.

In order for the installation components that communicate with one another using a secure protocol to be able to mutually validate their certificates, each of the components must be provided with the trust chain in each case of the other components. During the mutual certificate validation, the certificates of the communication partners of the components and also all the CA certificates that are contained in the associated trust chain are validated.

An obligatory step during the validation is the validation of the revocation status of the respective (CA) certificate. Here, a check is performed as to determine whether the certificate is published on a certificate revocation list (CRL) that is issued and signed by the relevant certification authority (issuing CA). In general, the certificate revocation list is stored by the issuing CA on a CRL distribution point (CDP) and the address of the CRL distribution point is adopted into the certificate by the issuing CA. It is thereby possible for each installation component to check the revocation status of its own certificate itself and to also check the certificates of the communication partners of the installation component because the installation component “retrieves” the certificate revocation list from the corresponding CDP and checks whether the certificate revocation list contains the respective certificates.

The communication networks of technical installations are heavily segmented according to customary security recommendations (for example, in accordance with the International Electrotechnical Commission (IEC) standard 62443). Each network segment in this case represents an autarchic functioning security cell. Generally, the access to the devices/installation components in such a cell is heavily regulated and is provided via a dedicated access point (for example, a firewall). The same approach has also proven expedient in securing the individual modules of a modular technical installation against unauthorized accesses.

WO 2017/144056 A1 discloses a method for improving information security from vehicle to X communication, where the vehicle to X communication can be secured via at least one certificate.

EP 3 624 413 A1 discloses a basic method for the application of a certificate in the case of a registration authority of a technical installation by a component of the technical installation. A revocation of certificates is not dealt with in this context.

In conjunction with the above-described use of certificates for securing communication within a technical installation, it is possible for different problems to arise. Installation components that cannot reach a registration authority in a network technical manner cannot make their certificate requests directly to the registration authority. This can be because, for example, the installation components are connected to an installation bus and/or are in dedicated closed part networks in a network technical manner and therefore cannot build any connection to a registration authority. In some cases, the access could in fact be rendered possible via a configuration of adequate firewall regulations. In the case of a high number of installation components, this approach would conversely not be practical since too high a quantity of firewall regulations would lead to a lack of transparency and a high configuration outlay and maintenance outlay and also to increased susceptibility to error.

Moreover, it is not possible to guarantee that an access by the installation components that are located in different network segments to the up-to-date certificate revocation list always functions in the case of the check of the revocation status of the certificates of the component or the certificates of the communication partner. In order to ensure that the check of the revocation status in a (where applicable heavily segmented) installation (in which there are in particular network segments without direct access to the relevant issuing CAs and the associated CDPs) is possible in an unobstructed manner at any time, it is in fact recommended to configure a CDP in each network segment and to ensure that all the necessary certificate revocation lists are filed on each such CDP. The distribution of the certificate revocation lists to various CDPs (which is currently performed in general with the aid of rudimentary, purely applicative solutions, such as scripts and/or batch) is however associated from experience with a particularly high configuration outlay and is not reliable for this purpose. If a certificate revocation list (for example, owing to the network technical problems) is not immediately distributed or is not distributed at all after the re-issuing to all the CDPs, which is caused by the revocation of a certificate, this frequently leads to time outs in the validation of the dedicated certificates by the components themselves or the validation of the certificates of the communication partners.

By virtue of the fact that owing to the above-mentioned network technical problems it is possible for the installation components to be prevented i) from promptly requesting or renewing, when required, the necessary certificates for the communication with the other components, and also (ii) from accessing the required certificate revocation lists in order to check the revocation status of the certificate of the communication partner of said installation component, it is possible for a secure communication in the technical installation to be severely impaired or interrupted. As a consequence, the normal operation and the availability of a technical installation (as the uppermost protective aim with regard to security) is potentially severely at risk.

### SUMMARY OF THE INVENTION

In view of the foregoing, it is therefore an object of the invention to provide a control system for a technical installation, where the control system contributes to an increase of the availability of the technical installation in the case of a simultaneously increased security against manipulation.

This and other objects and advantages are achieved in accordance with the invention by a control system for a technical installation, in particular a production installation or process installation, an automating component system and by a use of a control system for the management of certificates.

The control system in accordance with the invention comprises at least one certification body, at least one first installation component and at least one second installation component, where the certification body is responsible for and configured to issue and revoke certificates for at least the first installation component and the second installation component. The control system is characterized in that a certificate revocation list service is implemented in the control system and the certificate revocation list service is configured to receive from the certification body a certificate revocation list having certificates that have been revoked by the certification body and configured to provide the certificate revocation list to the installation components, and that a certificate revocation list distribution service is implemented at least on the first installation component and the second installation component and the certificate revocation list distribution service is configured to receive the certificate revocation list from the certificate revocation list service and to store the certificate revocation list in a storage device of the respective installation component, where the certificate revocation list distribution service of an installation component is furthermore configured in each case to connect to the certificate revocation list distribution service on another installation component and to receive the certificate revocation list from this certificate revocation list distribution service on the other component.

The term “a control system” in the present context is understood to mean a computer aided technical system that comprises functionalities for the representation, operation and control of a technical system, such as a production installation or manufacturing installation. In the present case, the control system comprises at least one first installation component and one second installation component. Moreover, the control system can comprise “process-oriented” or “production-oriented” components that are used to control actuators or sensors.

The technical installation can be an installation from the process industry such as a chemical, pharmaceutical, petrochemical installation or an installation from the food or luxury food industry. This includes any installations from the production industry, plants in which, for example, cars or goods of all types are produced. Technical installations that are suitable for the implementation of the method in accordance with the invention can also come from the field of energy generation. Wind turbines, solar installations or power stations for the generation of energy are likewise included in the term “technical installation”.

An installation component can be individual measuring transducers for sensors or control devices for actuators of the technical installation. An installation component can, however, also be a combination of multiple such measuring transducers or control devices, such as a motor, a reactor, a pump or a valve system. Superordinate devices, such as an automating device, an engineering station server, an operator station server or a decentralized peripheral, are likewise to be included under the term “installation components”. An automating device in this case is a technical device that is used so as to realize an automation. Here, it can be, for example, a storage programmable controller that represents a superordinate control function for subordinate controllers. The term “an operator station server” in this present case is understood to mean a server that captures and makes available to users central data of an operating and monitoring system and also in general alarm and measuring value archives of a control system of a technical installation. The operator station server in general produces a communication connection to automating systems (such as, an automating device) of the technical installation and relays data of the technical installation to “clients” and the data is used so as to operate and monitor an operation of the individual function elements of the technical installation.

The operator station server can comprise client functions in order to access the data (archives, messages, tags, variables) of other operator station servers. As a consequence, images of an operation of the technical installation on the operator station server can be combined with variables of other operator station servers (server-server communication). The operator station server can be a SIMATIC PCS 7 industrial workstation server of the company SIEMENS without being limited to this.

The term “an engineering station server” in the present case is understood to mean a server that is configured to create, manage, archive and document different hardware and software projects for a control system of a technical installation. With the aid of special software design tools (engineering toolset) and also prefabricated elements and plans, it is possible via the engineering station server to plan and manage a cooperation of control technical devices and facilities of the technical installation. One example for such an engineering station server is a SIMATIC manager server of the company SIEMENS.

The certification body can also be referred to as an “issuing CA (certification authority)” and issues certificates for diverse applicants based on incoming certification requests, and the certificates are signed by the certification body using its own certificate. The trustworthiness of the certification authority can be ensured because its own certificate is signed by the certificate of a trustworthy root certification authority (“root CA”) that is located in a secured environment. The certification authority cannot merely issue certificates but, rather, can also revoke these certificates. A corresponding revocation request of an installation component, whose certificate is to be revoked, is generally required for the certification authority to revoke or withdraw a certificate.

The term “a certificate” is understood to mean a digital dataset in accordance with the standard X.509 (RFC 5280) that confirms the specific characteristics (in this case of machines, devices, and/or applications). An authenticity and integrity of the certificate can generally be verified via cryptographic methods. A certificate can be an operative certificate, which is used for communication between different installation components of the technical installation, or can be a component-inherent certificate that is also referred to as a manufacturer certificate, or can be a comparable certificate.

The certificate revocation list distribution service stores the certificate revocation list in the storage device of the respective installation component in order to be able to provide this certificate revocation list both to the installation component itself, as well as to further certificate revocation list distribution services of other installation components. For example, if it is not possible for an installation component to directly reach the certificate revocation list service in the network of the control system, it is possible for the certificate revocation list service that is implemented on this installation component to turn to another certificate revocation list distribution service of another installation component in order to obtain an up-to-date certificate revocation list (which the certificate revocation list distribution service can use to validate a validity of certificates within the scope of communication that is to be established with other installation components). A security of the technical installation can consequently be maintained itself in the event of a failure of some safety components or the interruption of communications connections, which in general can increase the safety with respect to failure of the technical installation.

It can accordingly be rendered possible by the hierarchical arrangement of certificate revocation list service and the certificate revocation list distribution services that the certificate revocation lists when required are available always up to date and can be reached by the installation components.

The certificate revocation list service in accordance with the invention is configured to receive the certificate revocation list from the certification body. This does not necessarily mean the certificate revocation list service must obtain the certificate revocation list directly from the certification body. On the contrary, the certification body can also store the certificate revocation list at a special certificate revocation list distribution point (CDP) from where the certificate revocation list service then retrieves the certificate revocation list. The certificate revocation list is therefore in this case received indirectly.

It is preferred that the certificate revocation list service has a storage device in which it is possible to store the certificate revocation list that is received from the certification body. As a consequence, on the one hand, it is possible to reduce network loads and, on the other hand, it is possible to optimize the performance capability of the certificate revocation list service.

Within the scope of an advantageous embodiment of the invention, it is possible for the certificate revocation list service to comprise a variable configuration to the effect that preferably within the scope of project planning of the technical installation (in other words, during an engineering phase) it is possible to determine which certification body the certificate revocation list service connects to in order to obtain the certificate revocation list. The configuration can also be derived, for example, automatically from the communication dependencies of the installation components that are planned in the context of the technical installation. The certificate revocation list service could also search independently for addresses of certification bodies (or corresponding certificate revocation list distribution points) within the control system of the technical installation (with reference to typically used network addresses, specific address patterns or the like). This could, however, initiate a higher communication outlay with respect to the advantageous development of the invention.

It is particularly preferred that a certificate service is implemented in the control system and the certificate service is directly connected (or indirectly connected via a registration authority) to the certification body, where the installation components can direct certificate requests and revocation requests for certificates to the certification body with the aid of the certificate service. The certificate service offers the possibility of relaying certificate requests (initial or renewal) or revocation requests to the certification body (directly or indirectly), if for different reasons it is not possible for this certification body to be directly reached by the respective installation components. It is consequently possible in the sense of the robustness for failed communication paths to be bridged or in the sense of the installation security for direct communication paths to be reduced.

Advantageously, information is stored at least on the first installation component and the second installation component regarding of which network address the certificate service and/or the certificate revocation list service possess. It is consequently possible in a simple and efficient manner for the respective certificate revocation list distribution service to retrieve the up-to-date certificate revocation list and to store the certificate revocation list in the storage device of the certificate revocation list distribution service.

Within the scope of the preferred embodiment of the invention, the certificate service is implemented on an installation component that has access to both an installation bus, as well as to a terminal bus of the technical installation. The installation bus in this case is used for communication between “lower” hierarchical levels of the technical installation, such as measuring transducers, decentralized peripherals or automating devices. The terminal bus connects “higher” hierarchical levels of the technical installation such as an operator station client and an associated operator station server to one another. The terminal bus and the installation bus can be c for example as an industrial ethernet without being limited to this. The advantage of the presently contemplated embodiment resides in the fact that installation components that, for communication security reasons cannot communicate directly with the certification body (or the registration authority), can initially obtain, renew or withdraw their certificates via the certificate service.

It is also an object of the invention to provide an installation component system of a control system of a technical installation, where the installation component system has at least one first installation component and one second installation component in which, in each case, a certificate revocation list distribution service and a storage device are implemented, and where the certificate revocation list distribution service of the first installation component is configured to receive a certificate revocation list having certificates that have been revoked by a certification body and to transfer this certificate revocation list when required to the certificate revocation list distribution service of the second installation component and vice versa.

It is preferred that, in the case of the installation component system, information is stored on the first installation component and the second installation component regarding under which network address within the control system of the technical installation it is possible to retrieve the certificate revocation list and/or it is possible to apply for or to revoke a certificate.

It is an additional object of the invention to provide a control system, such as has been previously described, for use in the management of certificates that are to be assigned to installation components of a technical installation or are to be revoked for these installation components.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described characteristics, features and advantages of this invention and also the manner in which these are achieved become clearer and more explicitly understandable in conjunction with the following description of the exemplary embodiment that is further explained in conjunction with the drawings, in which:

The FIGURE is a schematic block diagram of a portion of a control system of a technical installation formed as a process installation in accordance with the invention.

### DETAILED DESCRIPTION OF THE EXEMPLARY EMBODIMENTS

A portion of a control system 1 in accordance with the invention of a technical installation that is formed as a process installation, in other words as a method-technical installation, is illustrated in the FIGURE. The control system 1 comprises an engineering station server 2, an operator station server 3, a maintenance server 4 and a management server 5. The control system 1 additionally comprises an engineering station client 6, an operator station client 7 and an automating device 8.

The engineering station server 2, the operator station server 3, the maintenance server 4, the management server 5, the engineering station client 6 and the operator station client 7 are connected to one another via a terminal bus 9 and are optionally connected to further components (not illustrated) of the control system 1, such as a process data archive.

A user or operator can access the operator station server 3 to operate and monitor via the operator station client 7 via the terminal bus 9. A project engineer or operator has access to the engineering station server 2 via the engineering station client 6 via the terminal bus 9 in the context of engineering/project planning/configuring. The terminal bus 9 can be formed, for example, as an industrial Ethernet without being limited to this.

The engineering station server 2 has an interface 10 that is connected to an installation bus 11. It is possible, via this interface 10, for the engineering station server 2 to communicate with the automating device 8 and also with further components of the process installation that are optionally provided. In the present exemplary embodiment, a switch 12 is connected to the installation bus 11, where the switch coordinates communication between different participants via the installation bus 11. The installation bus 11 can be formed, for example, as an industrial Ethernet without being limited to this. The automating device 8 can be connected to an arbitrary number of subsystems (not illustrated).

A certification body 13 (issuing CA) and a registration authority 14 (RA) is implemented on the management server 5. The certification body 13 can alternatively also be implemented on a dedicated server. A certificate service 15 is implemented on the operator station server 3. Installation components, such as the maintenance server 4, the engineering station server 2 or the automating device 8, can place a certification request (i.e., a request to receive an issued certificate) to the certificate service 15. The certificate service 15 relays this request to the registration authority 14 that relays the certificate request (after, where applicable, a check is performed to determine whether the installation component is entitled to a certificate) to the certification body 13. This certification body checks the certificate request for validity and, in the case of success, issues a certificate for the installation component that is applying.

An installation component can also relay a revocation request (so as to revoke an existing certificate) to the certificate service 15. This revocation request takes the above-described path to the certification body 13 that withdraws (revokes) the certificate. A certificate revocation list service 16 is implemented on the management server 5 and the certificate revocation list service receives an up-to-date certificate revocation list from the certification body 13 and the certificate revocation list comprises at least the previously withdrawn certificate. The certificate revocation list service 16 can also receive certificate revocation lists from external certification bodies 18, i.e., certification bodies that are located outside the process installation. The certificate revocation list is stored in a storage device (not illustrated) of the certificate revocation list service 16 in order to be able, when required, to be retrieved and distributed as follows.

In each case, a certificate revocation list distribution service 17a, 17b, 17c, 17d, 17e is implemented on the installation components (here the engineering station server 2, the operator station server 3, the engineering station client 6, the operator station client 7 and the automating device 8). The certificate revocation list distribution service 17a, 17b, 17c, 17d, 17e can each connect via the connecting paths that are known to the certificate revocation list distribution service to the certificate revocation list service 16, provided that a direct connection is possible in order to be able to relay the certificate revocation lists to the respective installation components upon which the certificate revocation list distribution services 17a, 17b, 17c, 17d, 17e are implemented.

The certificate revocation list distribution service 17a, 17b that is implemented on the engineering station server 2 and the operator station server 3 can access both the installation bus 11 as well as the terminal bus 9. The certificate revocation list distribution service 17e on the automating device 8 in the present exemplary embodiment can access the certificate revocation list service 16 via the certificate revocation list distribution service 17a of the engineering station server 2 or via the certificate revocation list distribution service 3 of the operator station server 3 in order when required (for example, in the case of building communication to a new communication partner) to be able to access the prevailing certificate revocation list of the certification body 13. The certificate revocation list distribution services 17a, 17b, 17c, 17d, 17e are accordingly arranged in a branched structure within which a failure of a communication connection can be compensated by the use of an alternative route. As a consequence, it is possible to clearly increase the availability of the process installation.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A control system for a technical installation, comprising:
at least one certification body;
at least one first installation component; and
at least one second installation component;
wherein the certification body is configured to issue and revoke revoking certificates for at least the first installation component and the second installation component;
a certificate revocation list service configured to receive from the certification body a certificate revocation list having certificates which have been revoked by the certification body and configured to provide said certificate revocation list to the installation components; and
a certificate revocation list distribution service implemented at least on the first installation component and the second installation component, said certificate revocation list distribution service being configured to receive the certificate revocation list from the certificate revocation list service and to store said certificate revocation list in a storage device of the respective installation component;
wherein the certificate revocation list distribution service of an installation component is further configured in each case to connect to the certificate revocation list distribution service on another installation component and to receive the certificate revocation list from this certificate revocation list distribution service on the other component.

2. The control system as claimed in claim 1, wherein the certificate revocation list service includes a storage device in which the certificate revocation list that is received from the certification body ( ) is storable.

3. The control system as claimed in claim 1, wherein the certificate revocation list service comprises a variable configuration such that during project planning of the technical installation it is possible to determine which certification body the certificate revocation list service connects to in order to obtain the certificate revocation list.

4. The control system as claimed in claim 2, wherein the certificate revocation list service comprises a variable configuration such that during project planning of the technical installation it is possible to determine which certification body the certificate revocation list service connects to in order to obtain the certificate revocation list.

5. The control system as claimed in claim 1, further comprising:
a certificate service which is directly or indirectly connected via a registration authority to the certification body;
wherein the installation components with the aid of the certificate service can direct certificate requests and revocation requests for certificates to the certification body.

6. The control system as claimed in claim 1, wherein information is stored at least on the first installation component and the second installation component regarding which network address is possessed by at least one of the certificate service and the certificate revocation list service.

7. The control system as claimed in claim 1, wherein the certificate service is implemented on an installation component which has access to both an installation bus and a terminal bus of the technical installation.

8. The control system as claimed in claim 1, wherein the technical installation comprises a production installation or process installation.

9. An installation component system of a control system of a technical installation, comprising:
at least one first installation component; and
one second installation component in which a certificate revocation list distribution service and a storage device are each implemented;
wherein the certificate revocation list distribution service of the first installation component is configured to receive a certificate revocation list having certificates which have been revoked by a certification body and to transfer said certificate revocation list when required to the certificate revocation list distribution service of the second installation component and the certificate revocation list distribution service of the second installation component is configured to receive the certificate revocation list having certificates which have been revoked by the certification body and to transfer said certificate revocation list when required to the certificate revocation list distribution service of the first installation component.

10. The installation component system as claimed in claim 9, wherein information is stored on the first installation component and the second installation component regarding under which network address within the control system of the technical installation it is possible to at least one of (i) retrieve the certificate revocation list and (ii) apply for or to revoke a certificate.

11. The control system as claimed in claim 1, wherein the control system manages certificates which are to be assigned to installation components of a technical installation or which are to be revoked for these installation components.
